(19) United States
(12) Patent Application Publication
(10) Pub. No.: US 2005/0256779 A1
(43) Pub. Date: Nov. 17, 2005

(54) Method and system for enabling a customer to monitor and alter an order in a semiconductor manufacturing environment

(75) Inventors: Cheng-Yao Ni, Jhubei City (TW); Chien-Jen Chen, Yonghe City (TW); Hsin-Shen Lan, Hsinchu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/845,842

(22) Filed: May 14, 2004

(51) Int. Cl. G06F 17/60

(52) U.S. Cl. 705/26

(57) ABSTRACT

A system and method for enabling a customer to monitor and modify an order in a semiconductor manufacturing system are provided. In one example, the method provides the customer with current information on the order, including a position of the order within the manufacturing process. The customer may request that the order be modified and the system may then determine when to implement the requested modification.

### BACKGROUND

The present disclosure relates generally to the field of semiconductor manufacturing and, more particularly, to a system and method for altering an order in a semiconductor manufacturing system via a communications network.

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC may be formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) have become limited by the fabrication process.

Furthermore, as the IC industry has matured, the various operations needed to produce an IC may be performed at different locations by a single company or by different companies that specialize in a particular area. This further increases the complexity of producing ICs, as companies and their customers may be separated geographically, making effective communication more difficult. For example, a first company (e.g., an IC design house) may design a new IC, a second company (e.g., an IC foundry) may provide the processing facilities used to fabricate the design, and a third company may assemble and test the fabricated IC. A fourth company may handle the overall manufacturing of the IC, including coordination of the design, processing, assembly, and testing operations.

Because of the complexity of IC manufacturing, it may be difficult for a customer to change an existing order. Generally, a customer wanting to make a change in their order requests the change through a customer service individual or an engineer. The change may then be passed on to an engineering team, such as a production control engineer (PCE) team or a process integration engineer (PIE) team. The change may need to be converted into a manufacturing order for execution by the PCE or PIE team. This process introduces delays due to the need for human interaction, inconsistent service (e.g., no service may be available on weekends and holidays), and may also introduce errors into the manufacturing process.

Accordingly, what is needed is an improved system and method for enabling a customer to view and alter an existing order in a semiconductor manufacturing system.

### BRIEF DESCRIPTION OF THE DRAWINGS

FIG. 1 is a diagram of one embodiment of an exemplary semiconductor manufacturing system in which a customer initiated order change may be implemented.

FIG. 2 is a flow chart of one embodiment of an exemplary method for implementing the customer initiated order change within the manufacturing system of FIG. 1.

FIG. 3 is a flow chart of another embodiment of an exemplary method for implementing the customer initiated order change within the manufacturing system of FIG. 1.

FIG. 4 is a diagram of another embodiment of an exemplary semiconductor manufacturing system in which a customer initiated order change may be implemented.

FIG. 5 is a flow chart of an embodiment of an exemplary method for implementing the customer initiated order change within the manufacturing system of FIG. 4.

FIG. 6 is a diagram of an exemplary virtual integrated circuit fabrication system that may include the exemplary semiconductor manufacturing systems of FIGS. 1 and 4.

### DETAILED DESCRIPTION

The present disclosure relates generally to the field of semiconductor manufacturing and, more particularly, to a system and method for altering an order in a semiconductor manufacturing system via a communications network. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

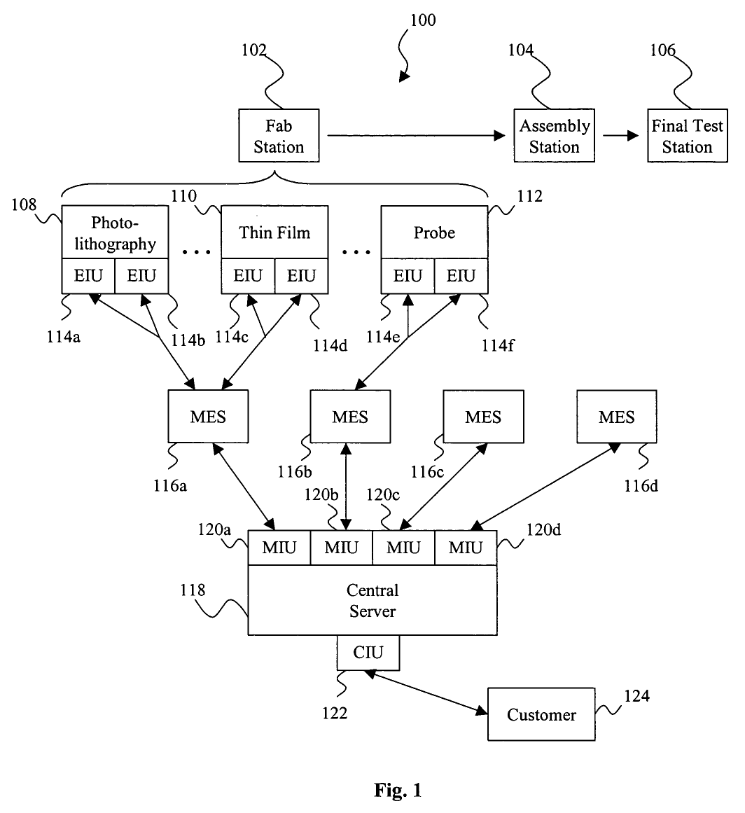

Referring to FIG. 1, in one embodiment, an exemplary semiconductor manufacturing system 100 enables a customer to monitor and/or modify an order during a semiconductor manufacturing process. The system 100 includes a fabrication station (fab) 102, an assembly station 104, and a final test station 106. Each of these systems may include one or more additional substations, systems, or processes. For example, the fab 102 may include photolithography equipment 108, thin film equipment 110, and probe equipment 112. Each of these may be further divided into various pieces of equipment containing hardware and/or software, equipment components, processes, etc.

Each of the stations 102, 104, 106, includes at least one equipment interface unit (EIU) 114a-114f that enables the associated equipment to correspond with a manufacturing execution system (MES) 116a-116d. Each MES 116a-116d may be an integrated computer system representing methods and tools used to accomplish production of a semiconductor device. For example, each MES 116a-116d may collect data in real time, organize and store the data in a centralized database, and perform operations related to work order management, workstation management, process management, inventory tracking, and document control. It is understood that each MES 116a-116d may be based on a different technology, such as PROMIS (Brooks Automation Inc. of Massachusetts), WORKSTREAM (Applied Materials, Inc. of California), POSEIDON (IBM Corporation of New York), MIRL-MES (Mechanical Industry Research Laboratories of Taiwan), and/or may include a Petri net.

Also included in the system 100 is a central server 118. The central server 118 is associated with a plurality of MES interface units (MIUs) 120a-120d that are positioned between each MES 116a-116d and the central server 118. The MIUs 120a-120d enable the central server 118 to communicate with each MES 116a-116d despite differences in the technologies supported by each MES. For example, one MIU may enable the server 118 to communicate with an MES based on PROMIS, while another MIU may enable the server to communicate with an MES based on MIRL-MES. In this manner, a new MIU may be added to support communication between the server 118 and a new MES. Also associated with the central server 118 is a customer interface unit (CIU) 122. The CIU 122 enables communication to occur between the central server 118 and a customer 124.

Each interface (e.g., EIUs 14a-114f, MIUs 120a-120d, and CIU 122) may be implemented using software and/or hardware. For example, the MIU 120a-120d may be a software component installed on the central server 118. Furthermore, various EIUs, MIUs, and/or CIUs, may be combined. For example, a single MIU may be provided with multiple interfaces. Additionally, some components may be installed elsewhere or may be configured as standalone devices. For example, an MIU may comprise a portion of an MES, rather than the central server 118.

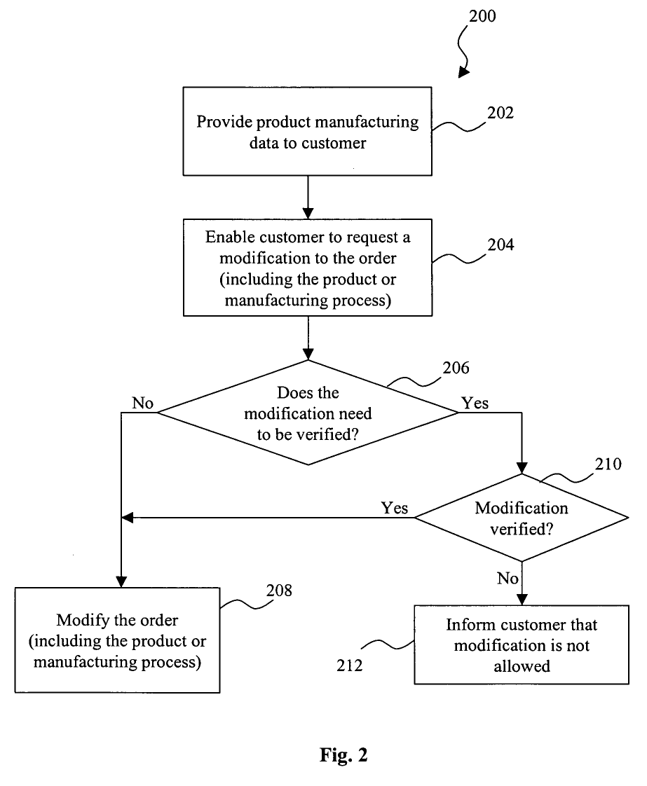

Referring now to FIG. 2, a method 200 illustrates one embodiment of a method that may be executed within the system 100 of FIG. 1 to enable a customer to monitor and/or modify an order during a semiconductor manufacturing process. The system 100 may use the various components described in FIG. 1 to perform operations needed for the execution of the method 200, such as retrieving data to identify the order's location in the manufacturing process. Although portions of the system 100 may be described as performing certain operations with respect to the method 200, it is understood that this is for purposes of example only.

In step 202, data is provided to the customer 124 by the manufacturing environment via the CIU 122. For example, the customer 124 may log into the central server 118 of the system 100 via the CIU 122 and initiate a request to view a particular order. The central server 118 may identify a location of the order (e.g., the product or lot associated with the order) within the system 100 and communicate with the proper MES 116a-116d. For example, the product may be undergoing a process using the thin film equipment 110. Accordingly, the central server 118 may contact the MES 116a to obtain data about the product.

The data provided to the customer 124 may include, but is not limited to, lot numbers, product identification numbers, processing steps used to manufacture the product, process step variables (e.g., duration of processing, temperature, pressure, chemicals used, etc.), testing information, shipping information, and any other data that may be associated with the product during its manufacture. It is understood that the term “manufacturing” may include the conception and design of the product, the actual creation and testing of the product, and shipping the product to the customer or another destination. Some of the data may be based on information entered or provided by the customer 124, while other data may be provided by a manufacturer.

In step 204, the customer 124 may alter the order by modifying the product and/or the associated manufacturing process used to fabricate the product. The modification may affect a processing or order handling operation that occurs during the manufacturing of an integrated circuit (IC). For example, the modification may affect a processing operation by requesting that a layer of the IC be made thicker or thinner, or it may include such order handling operations as splitting a lot, merging lots, holding a lot, or releasing a lot. The order may be identified by the customer using a predefined identifier (e.g., a system assigned value, such as an order number, a part number, or a lot number, or it may be a customer selected number). In some embodiments, the system 100 may convert a customer identifier to a system identifier using, for example, a lookup table.

In step 206, a determination may be made as to whether the modification entered by the customer 124 in step 204 needs to be verified. It is understood that some modifications to an order may not need to be verified (e.g., increasing an order quantity from 2000 units to 4000 units), while other modifications may require verification (e.g., changing a chemical composition of a process step). In some embodiments, the customer 124 may enter a modification at any time, while in other embodiments, the customer may only be allowed to enter modifications that may still be implemented. For example, if the customer 124 attempts to modify a process step that has already been performed, the system 100 may inform the customer that the modification is not allowed. In some embodiments, the system 100 may show only allowed modifications to the customer 124 to prevent the customer 124 from selecting or requesting a modification that is not allowed.

If it is determined in step 206 that no verification is needed, the method 200 may continue to step 208 where the order (including the associated product and/or manufacturing process) may be modified. If it is determined in step 206 that verification is needed, the method 200 may continue to step 210, where a determination is made as to whether the modification is verified. If the modification is verified, the method 200 moves to step 208 and the order may be modified as previously described. If the modification is not verified, then the customer 124 may be informed that the modification is not allowed in step 212. Although not shown in the method 200, in some embodiments, the customer 124 may return to step 204 and make new or additional modifications.

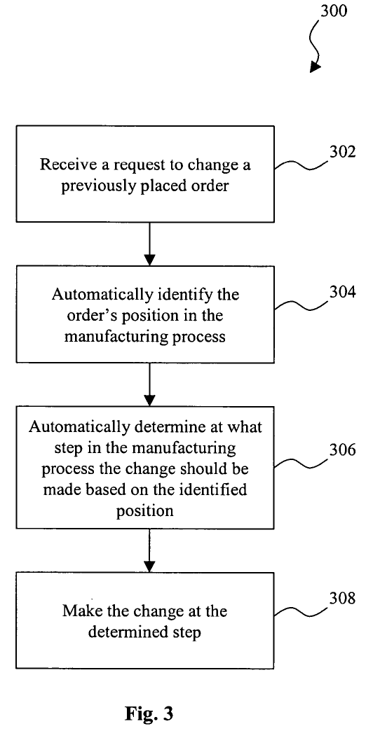

Referring now to FIG. 3, in another embodiment, a method 300 may be executed within a semiconductor manufacturing system (e.g., the system 100 of FIG. 1) to make a modification to an existing order. In step 302, a request may be received from a customer to change a previously placed order. As previously described with respect to FIG. 2, the change may include modifications to a product and/or a manufacturing process associated with the order. In step 304, the order's position in the manufacturing process may be identified. For example, if the order is currently involved in a particular semiconductor fabrication step, this information may be retrieved.

In step 306, a determination may be made as to where in the manufacturing process the requested modification should be made. This determination may be based at least partly on the identified position of the order. Depending on the position of the order in the manufacturing process, it may be difficult or impossible to change the order until a certain step is reached and the order can be “held.” For example, if the order is currently involved in a process or a series of processes that cannot be stopped without damaging the product, then the modification may not be made until after the process is complete. However, if the order is being cancelled, then it may be desirable to stop the order immediately, as damage to the order may not be relevant. It is understood that some modifications may not require the order's position in the manufacturing process, such as increasing a quantity of units being ordered. In step 308, the change may be implemented at the time or place determined in step 306.

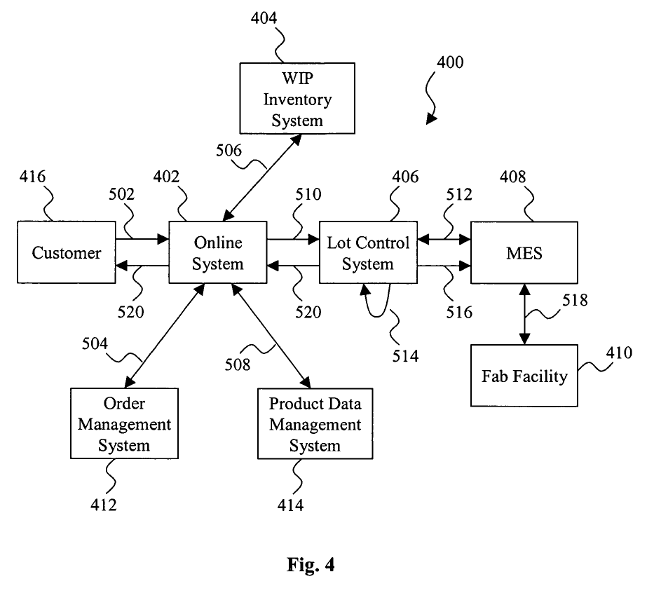

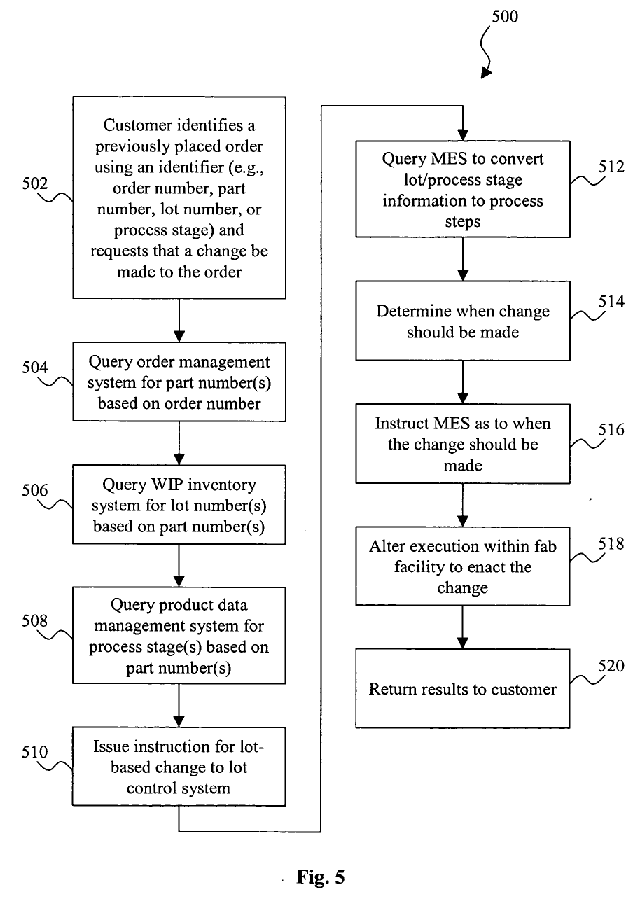

Referring now to FIG. 4, an exemplary system 400 may be used to enable a customer to change an order in a semiconductor manufacturing system. The system 400 includes an online system 402, a work-in-process (WIP) inventory system 404, a lot control system 406, an MES 408, a fab facility 410, an order management system 412, a product data management system 414. A customer 416 may interact with the system 400 to initiate the order change, as described in greater detail with respect to FIG. 5.

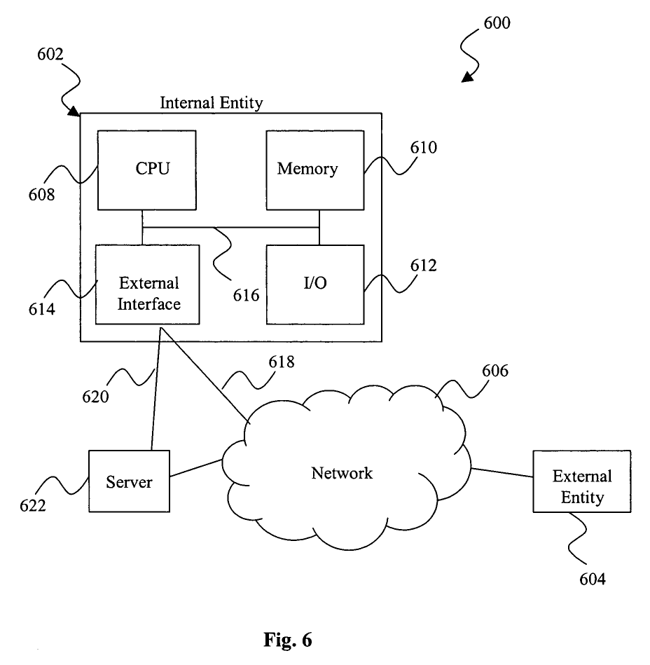

Referring to FIG. 5 and with continued reference to FIG. 4, a method 500 may be used to change an order (e.g., a purchase order) during a manufacturing process within the system 400 of FIG. 4. For purposes of example, the order involves the manufacture of an IC, and is associated with one or more identifiers that are used by a virtual fab (illustrated in greater detail in FIG. 6) to track the progress of the order through the manufacturing process. Exemplary identifiers include an order number, a part number, a lot number, a process stage, or a process step.

The customer 416 may have more than one order and each order may be stored in the order management system 412. Each order may include several parts (e.g., types of products). Each part in the order may be divided into several lots. A lot may contain several wafers, where a wafer is a basic manufacturing unit. For example, a certain amount of wafers may be grouped together as one lot (e.g., twenty-five wafers per lot), and each wafer in the lot will go through the same manufacturing process. The lot distribution may be handled by a dynamic database that is maintained by the WIP inventory system 404. Each lot goes through one or more process stages. A stage is a group of manufacturing process steps. The process stage associated with each part may be maintained by the product data management system 414. A particular part should be associated with the same set of process stages. Each process stage may contain several process steps, which are the smallest process procedures in the manufacturing process. The lot control system 406 may convert a process stage to its corresponding process steps using information contained in the MES system 408.

Because the customer generally does not know where the lots of the order are in the manufacturing process and does not know when the change should be made, the method 500 uses information available via the system 400 to make the change at the appropriate place in the manufacturing process. For example, the customer may be able to reference an order by identifier number, part number, lot number, or process stage, but generally does not have access to the process steps within a process stage. Furthermore, even if the customer knows the process steps, the customer may not know which process steps the lots of the order would undergo nor when the change should be made. Additionally, the manufacturing process for the lots of the order may be adjusted by lot parameters, and it may be difficult to make the change until a certain point is reached.

In step 502, the customer 416 logs into the online system 402 and requests that one or more changes be made to an order. The order may be identified by order number, part number, lot number, process stage, etc. The online system 402 is linked to the order management system 412, the WIP inventory system 404, the product data management system 414, and the lot control system 406. In step 504, the online system 402 queries the order management system 412 for part numbers associated with the order change. The order management system 412 may resolve the query by converting from the order number to the parts which are associated with the order based on its order database. In steps 506, 508, the online system 402 queries the WIP inventory system 404 and the product data management system 414 for WIP information and process stage information, respectively. The WIP system 404 may resolve the query by converting from the part numbers retrieved in step 504 to one or more lots that are associated with the order based on its WIP database. The product data management system 414 may resolve the query by converting from the part number to process stages that are associated with the part based on its product database. It is understood that one or more of the steps 504-508 may not be executed if the customer provides more detailed information. For example, if the customer requests the change using the part number, then the order management system 412 may not be queried.

In step 510, the online system 402 may issue a change request based on the lot number to the lot control system 406. The change request may include a lot number, a part number and a process stage number to identify a particular portion of the order that is to be changed. The lot control system 406 may be responsible for converting the change request from a process stage-based change to a process step-based change. This enables the change to be made at a particular point in the manufacturing process. This conversion from a process stage to process steps may utilize the MES system 408, which contains information linking process steps to each product (part). Accordingly, in step 512, the lot control system 406 transfers the lot/process stage information to the MES 408, requests the associated process step information, and receives the process step information after the MES 408 has converted the lot/process stage information to the corresponding steps.

In step 514, the lot control system 406 uses the process step information to determine at which process step the change should be made. The result of this determination is passed to the MES 408 in step 516, which uses the result to manage the execution of the change within the fab facility 410 in step 518. In step 520, the change is acknowledged to the customer 416 via the lot control system 406 and the online system 402.

Referring now to FIG. 6, a virtual IC fabrication system (a “virtual fab”) 600 may incorporate either of the systems 100 and 400 of FIGS. 1 and 4. For example, various components of the systems 100, 400 may be included in or represented by the entities of the virtual fab 600. The virtual fab 600 includes a plurality of entities represented by one or more internal entities 602 and one or more external entities 604 that are connected by a communications network 606. The network 606 may be a single network or may be a variety of different networks, such as an intranet and the Internet, and may include both wireline and wireless communication channels.

Each of the entities 602, 604 may include one or more computing devices such as personal computers, personal digital assistants, pagers, cellular telephones, and the like. For the sake of example, the internal entity 602 is expanded to show a central processing unit (CPU) 608, a memory unit 610, an input/output (I/O) device 612, and an external interface 614. The external interface may be, for example, a modem, a wireless transceiver, and/or one or more network interface cards (NICs). The components 608-614 are interconnected by a bus system 616. It is understood that the internal entity 602 may be differently configured and that each of the listed components may actually represent several different components. For example, the CPU 608 may actually represent a multi-processor or a distributed processing system; the memory unit 224 may include different levels of cache memory, main memory, hard disks, and remote storage locations; and the I/O device 612 may include monitors, keyboards, and the like.

The internal entity 602 may be connected to the communications network 606 through a wireless or wired link 618, and/or through an intermediate network 620, which may be further connected to the communications network. The intermediate network 620 may be, for example, a complete network or a subnet of a local area network, a company wide intranet, and/or the Internet. The internal entity 602 may be identified on one or both of the networks 606, 620 by an address or a combination of addresses, such as a MAC address associated with the network interface 614 and an IP address. Because the internal entity 202 may be connected to the intermediate network 620, certain components may, at times, be shared with other internal entities. Therefore, a wide range of flexibility is anticipated in the configuration of the internal entity 602. Furthermore, it is understood that, in some implementations, a server 622 may be provided to support multiple internal entities 602. In other implementations, a combination of one or more servers and computers may together represent a single entity.

In the present example, the internal entities 602 represents those entities that are directly responsible for producing the end product, such as a wafer or individually tested IC devices. Examples of internal entities 602 include an engineer, customer service personnel, an automated system process, a design or fabrication facility and fab-related facilities such as raw-materials, shipping, assembly or test. Examples of external entities 604 include a customer, a design provider, and other facilities that are not directly associated or under the control of the fab. In addition, additional fabs and/or virtual fabs can be included with the internal or external entities. Each entity may interact with other entities and may provide services to and/or receive services from the other entities.

It is understood that the entities 602, 604 may be concentrated at a single location or may be distributed, and that some entities may be incorporated into other entities. In addition, each entity 602, 604 may be associated with system identification information that allows access to information within the system to be controlled based upon authority levels associated with each entities identification information.

The virtual fab 600 enables interaction among the entities 602, 604 for purposes related to IC manufacturing, as well as the provision of services. In the present example, IC manufacturing can include one or more of the following steps:
receiving or modifying a customer's IC order of price, delivery, and/or quantity;
receiving or modifying an IC design;
receiving or modifying a process flow;
receiving or modifying a circuit design;
receiving or modifying a mask change;
receiving or modifying testing parameters;
receiving or modifying assembly parameters; and
receiving or modifying shipping of the ICs.

One or more of the services provided by the virtual fab 600 may enable collaboration and information access in such areas as design, engineering, and logistics. For example, in the design area, the customer 604 may be given access to information and tools related to the design of their product via the fab 602. The tools may enable the customer 604 to perform yield enhancement analyses, view layout information, and obtain similar information. In the engineering area, the engineer 602 may collaborate with other engineers 602 using fabrication information regarding pilot yield runs, risk analysis, quality, and reliability. The logistics area may provide the customer 604 with fabrication status, testing results, order handling, and shipping dates. It is understood that these areas are exemplary, and that more or less information may be made available via the virtual fab 600 as desired.

Another service provided by the virtual fab 600 may integrate systems between facilities, such as between a facility 604 and the fab facility 602. Such integration enables facilities to coordinate their activities. For example, integrating the design facility 604 and the fab facility 602 may enable design information to be incorporated more efficiently into the fabrication process, and may enable data from the fabrication process to be returned to the design facility 604 for evaluation and incorporation into later versions of an IC.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

1. A method for enabling a customer to monitor and modify an order during semiconductor manufacturing using a centralized system, the method comprising:
providing manufacturing data to the customer via a computer, wherein the manufacturing data identifies a position of the order within a manufacturing process;
enabling the customer to request a modification to the order, wherein the request is made directly from the customer to the centralized system; and
approving or rejecting the requested modification if the modification must be verified before being implemented.

2. The method of claim 1 wherein approving or rejecting the requested modification is accomplished automatically by applying a set of design rules.

3. The method of claim 1 wherein the modification request is to modify a parameter associated with a product, a first process, or a first piece of equipment associated with the order.

4. The method of claim 3 further comprising incorporating the modification into the manufacturing process to alter the product, first process, or first piece of equipment prior to completing the manufacturing of the product.

5. The method of claim 3 wherein the manufacturing data includes a second process that is different from the first process, and wherein the method further comprises:
enabling the customer to make a modification to the second process; and
incorporating the modification into the manufacturing process to alter the second process prior to completing the manufacturing of the product.

6. The method of claim 5 further comprising providing an automated centralized access point accessible to both the customer and the centralized system, wherein the manufacturing data is provided to the customer for both the first and second processes using the centralized access point.

7. The method of claim 1 wherein providing manufacturing data to the customer occurs in real time.

8. A method for enabling a customer to directly monitor and modify an existing order during semiconductor manufacturing using a centralized system, the method comprising:
receiving a request from the customer via the centralized system to change the order;
automatically identifying a current position of the order in a manufacturing process having a plurality of steps;
automatically determining at which step of the plurality of steps the change should be made based at least partly on the current position; and
making the change at the determined step.

9. The method of claim 8 further comprising notifying the customer via the centralized system that the change has been made.

10. The method of claim 8 further comprising:
providing manufacturing data to the customer via the centralized system prior to making the change;
updating the manufacturing data after making the change; and
providing the updated manufacturing data to the customer via the centralized system.

11. The method of claim 8 wherein automatically determining at which step of the plurality of steps the change should be made includes:
based on the current position, identifying a first step occurring after the current position that is separable from the current position; and
determining if the first step is compatible with the change, wherein the compatibility identifies whether the change will negatively impact the first step.

12. The method of claim 11 further comprising, if the first step is not compatible with the change, identifying a second step occurring after the first step that is separable from the first step.

13. A method for changing an existing order during a manufacturing process in a semiconductor manufacturing system, wherein the order is assigned an identifier for tracking within the system, the method comprising:
receiving a request from a customer to change the order, wherein the request is received by the semiconductor manufacturing system directly from the customer;
querying an order management system for a part number based on the identifier;
querying a work-in-process inventory system for a lot number based on the part number;
querying a product data management system for at least one process stage based on the part number;
querying a manufacturing execution system to convert the lot number and process stage to a plurality of process steps; and
determining when the change should be made based on the plurality of process steps and a current position of the order in the plurality of process steps.

14. The method of claim 13 further comprising:
instructing the manufacturing execution system to make the change at a particular step of the plurality of process steps; and
altering an execution of the plurality of process steps within a fabrication facility to enact the change.

15. The method of claim 14 further comprising automatically notifying the customer that the change has been enacted.

16. A centralized system for enabling a customer to monitor and modify an order during a semiconductor manufacturing process, the system comprising:
at least one equipment interface unit (EIU) associated with each of a plurality of separate manufacturing stations, wherein each station includes at least one piece of equipment that may be accessed via the EIU;
at least one manufacturing execution system (MES) in communication with each EIU;
at least one MES interface unit (MIU) in communication with each MES;
a centralized server in communication with each MIU; and
a customer interface unit (CIU) in communication with the centralized server, wherein the CIU is adapted to provide access to the centralized server by the customer.

17. The centralized system of claim 16 further comprising a plurality of computer executable instructions, the instructions including
instructions for receiving a request from the customer at the centralized server via the CIU to change the order;
automatically identifying, by the server via the MIU and the MES, a current position of the order in a manufacturing process having a plurality of steps, wherein the current position identifies which station is currently processing the order;
automatically determining at which step of the plurality of steps the change should be made based at least partly on the current position; and
instructing the MES to make the change in the station at the determined step via the EIU.

18. The centralized system of claim 17 further comprising instructions for retrieving and providing manufacturing data to the customer, wherein the manufacturing data identifies the current position.

19. The centralized system of claim 18 wherein the manufacturing data is retrieved and provided to the customer in real time.

20. A system for automatically implementing a customer initiated modification to an order in a semiconductor manufacturing environment, the system comprising:
an online system;
a work-in-process (WIP) inventory system in communication with the online system;
an order management system in communication with the online system;
a product data management system in communication with the online system;
a lot control system in communication with the online system;
a manufacturing execution system (MES) in communication with the lot control system; and
a plurality of instructions including:
instructions for receiving a request from a customer to change the order via the online system;
instructions for querying, by the online system, the order management system for a part number based on an identifier associated with the order;
instructions for querying, by the online system, the work-in-process inventory system for a lot number based on the part number;
instructions for querying, by the online system, the product data management system for at least one process stage based on the part number;
instructions for querying, by the lot control system, the MES to convert the lot number and process stage to a plurality of process steps; and
instructions for determining when the change should be made based on the plurality of process steps and a current position of the order in the plurality of process steps.

21. The system of claim 20 further comprising:
a fabrication facility in communication with the MES;
instructions for instructing the MES to make the change at a particular step of the plurality of process steps; and
instructions for altering an execution of the plurality of process steps within the fabrication facility to enact the change.

22. The system of claim-2 further comprising instructions for automatically notifying the customer that the change has been enacted.
